(19) United States
(12) Patent Application Publication
(10) Pub. No.: US 2021/0373580 A1
(43) Pub. Date: Dec. 2, 2021

(54) System and method for autonomous air traffic control of unmanned aerial vehicles

(71) Applicant: Edgar Emilio Morales Delgado, San Francisco, CA (US)

(72) Inventor: Edgar Emilio Morales Delgado, San Francisco, CA (US)

(21) Appl. No.: 16/880,934

(22) Filed: May 21, 2020

(51) Int. Cl. G05D 1/10; G08G 5/00; B60W 60/00

(52) U.S. Cl. CPC G05D 1/104; G08G 5/003; G08G 5/0013; B60W 60/00256; G05D 2201/021; G05D 2201/0201; G05D 2201/0202; G05D 2201/0207; G05D 2201/0209; B60W 60/00259

(57) ABSTRACT

A method for autonomous air traffic control (AATC) of unmanned aerial vehicles (UAVs) comprising transporting a plurality of UAVs from an origin location to a destination location through a plurality of airspace regions, controlling the flight of said UAVs using a computer-based traffic management system, periodically tracking the flight of the UAVs, executing automated processes on the computer-based traffic management system and transmitting bi-directional information between the computer-based traffic management system and the UAVs through a communications network.

### BACKGROUND

The present invention relates to systems and methods for providing air traffic control to aerial vehicles without a human pilot. In particular the present invention is related to transportation of unmanned aerial vehicles capable of autonomous flight and to autonomous air traffic control systems.

Air traffic control (ATC) is a service that monitors and directs manned aircrafts on the ground and through a controlled airspace using human air traffic controllers. This system has been implemented globally since 1920, and has since then been effective for transportation of aircrafts. To prevent collisions, a minimum amount of separation distance between the aircrafts is enforced. However, the monitoring of aircrafts' location is based on radar, which requires a very large amount of infrastructure that has been developed and deployed over the last century. Additionally, the range of radar technology is limited to up to 200 miles from the coast. In situations exceeding such range, air traffic controllers monitor aircrafts via radio communications with the pilot, which are subject to human error and can be slow. This contributes to location uncertainty, requiring an even larger separation between aircrafts to ensure safety.

In the case of an unmanned aerial vehicle also known as drone, which is an aircraft that can fly without a human pilot on-board, the most basic control approach consists on a human pilot sending commands to the UAV through a wireless communications link. This is sufficient for some limited purposes, but not enough if more than one UAV are required to be flown over the same airspace in a safe manner. For transportation of multiple UAVs, a different method that allows safe simultaneous flights within a shared airspace is required.

Some approaches for transportation of payload using drones have been proposed (for example, see U.S. Pat. Nos. 9,959,733 B2 and 9,489,852 B1). In those methods, a flight route is generated before takeoff and is followed by the drone during the entire flight. However, they lack the possibility to modify the route in flight and there is no way to monitor and verify that the flights are occurring as expected. Such approaches might be effective in specific situations where a very small number of drones widely spaced one from another are flown without any eventualities happening. However, in real life scenarios, a safe drone transportation system that enables transportation of a very large number of aerial vehicles must be able to deal with a dynamic and changing environment where eventualities can occur, such as natural disasters, aircraft failures, changes in transportation demand, or sudden changes of weather conditions. In such scenarios, a supervised air traffic control is required, similar to what ATC does, as described above.

Another approach that has been proposed consists on a system-only traffic management system as described in US. Pat. 2016/0275801 A1. This system is limited to the control of unmanned aerial systems (UAS) exclusively in uncontrolled airspace at low altitudes. Moreover, it is based on rules that the UAS follow to navigate in the uncontrolled airspace and detects the location of UAS via surveillance, using radars or cellular networks. In contrast, the system and method proposed herein can control UAVs in both controlled and un-controlled airspace at both low and high altitudes. Moreover, in-flight and grounded UAVs frequently obtain their location via satellite based navigation, which is then periodically transmitted to a computer-based traffic management system. This allows a very precise knowledge of the location of all UAVs, enabling a larger UAV capacity of the system and a larger safety than existing approaches.

Considering the existing prior art, there is a need for an autonomous air traffic control (AATC) system and method for drones and unmanned aerial vehicles that can leverage all the principles and advantages of conventional manned air traffic control but that is custom to the specific needs required for UAV operations. Moreover, there is a need for a safe, efficient and reliable air traffic control system for UAVs that exploits the latest technologies of navigation, communications and cloud computing to control automatically the flight of UAVs with minimal or without human intervention.

### SUMMARY OF THE INVENTION

The invention disclosed herein includes a system and a method for controlling the air traffic and flight of multiple unmanned aerial vehicles in a safe, autonomous and efficient manner. To achieve this, the invention comprises the following components: a plurality of takeoff and landing stations, telecommunications infrastructure, a computer-based traffic management system, a plurality of unmanned aerial vehicles, a communications network and a plurality of airspace regions where the UAVs are flown. The telecommunications infrastructure enables bi-directional communications between the UAVs and the computer-based traffic management system. This way, UAVs can transmit their location and telemetry information to the traffic management system, which can track UAVs and know their exact current and future location in real-time. Moreover, flight plans, flight routes and flight parameters can be dynamically changed and communicated to individual UAVs, always ensuring a minimum safety separation between UAVs. This enables a safe and dynamic reconfiguration of the air traffic that can be adapted to different scenarios such as an increase in flight requests, change of weather conditions, or any kind of eventuality that might occur.

In contrast to the existing methods described in the section “BACKGROUND”, the invention disclosed herein can control UAVs in both controlled and un-controlled airspace at both low and high altitudes. Moreover, the periodic transmission of telemetry information from the UAVs to the computer-based traffic management system allows precise real-time monitoring of the location of all UAVs, enabling a larger UAV capacity and enhanced safety than existing approaches.

The invention disclosed herein is inspired by the principles of conventional manned air traffic control, but updated with the latest technologies of navigation, communications and cloud computing to control autonomously the flight of UAVs. This system allows air traffic control without or with minimal human intervention, it can operate inside and outside specifically designated airspace areas, it can operate safely and separated from commercial aviation and is compatible with existing uncontrolled operations such as helicopters used for emergency and rescue, light planes and hobbyists drones.

This AATC system enables new forms of transportation and air and delivery of goods in a fast, efficient and safe manner. It also enables safe multi-mission operations within a same shared airspace, with applications including and not limited to cargo delivery, transportation, search and rescue, mapping, surveillance, aerial photography, agriculture, entertainment, wildlife monitoring, mining, remote sensing, law enforcement, real state, infrastructure monitoring, construction monitoring and disaster assessment.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 Illustrates an example of the components comprising the AATC system in accordance with the system and methods of the present disclosure.

FIG. 2 Illustrates an example of route segments that connect an origin location to a destination location through a plurality of waypoints as specified in the flight plan, in accordance to the system and methods of the present disclosure.

FIG. 3 illustrates real-time tracking and control of a plurality of in-network UAVs transported under the control of the AATC system.

FIG. 4 shows exemplary UAVs being controlled by the AATC system, each UAV being used for a specific mission and application.

### DETAILED DESCRIPTION

Embodiments of systems, devices and methods for autonomous air traffic control of unmanned aerial vehicles are described herein. In the following description, numerous specific details are set forth to provide a thorough understanding of the embodiments. One skilled in the art will recognize, however, that the techniques described herein can be practiced without one or more of the specific details, or with other methods, components, materials, etc. In other words, well-know structures, materials or operations are not shown or describe in detail to avoid obscuring certain aspects.

The content of this disclosure may be applied to multiple fields, such as navigation, autonomous vehicles, air traffic control, autonomous air traffic control, aerial vehicles and unmanned aerial vehicles.

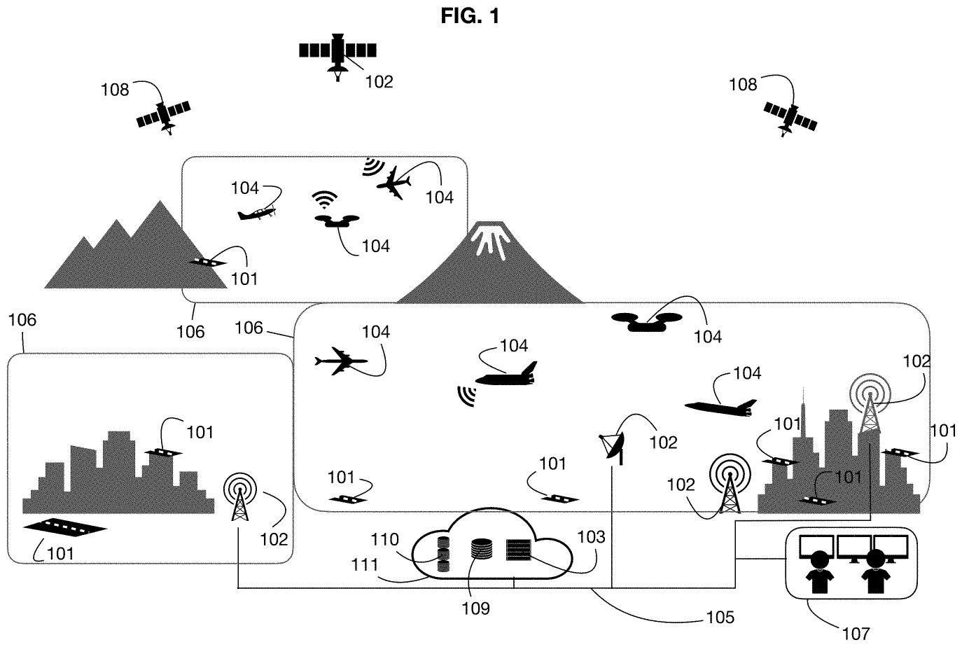

Reference throughout this specification to “one embodiment”, “an embodiment”, or “some embodiments” means that a particular feature, structure, or characteristic described may be included in at least one embodiment of the present invention, and each of these embodiments may be combined with other embodiments in accordance with the present disclosure. Thus, the appearances of the phrases “in one embodiment”, “in an embodiment”, or “in some embodiments” throughout this specification do not necessarily all refer to the same embodiment. Furthermore, the particular features, structures, or characteristics may be combined in any suitable manner in one or more embodiments. These embodiments and others will be described in more detail with references to FIGS. 1-4.

Throughout this specification, several terms of art are used. These terms are to take on their ordinary meaning in the art from which they come, unless specifically defined herein or the context of their use would clearly suggest otherwise. Also, like characters generally refer to like elements unless indicated otherwise. Some terms used in this specification and in the claims of this disclosure are defined in the “GLOSSARY” section.

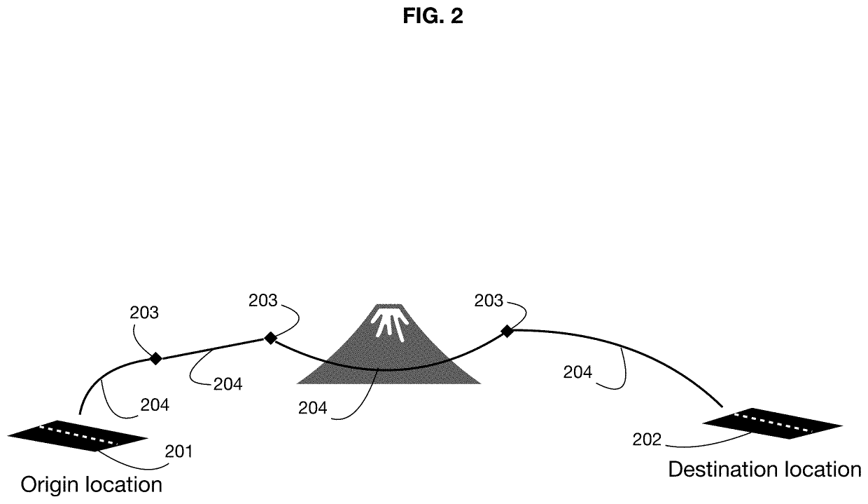

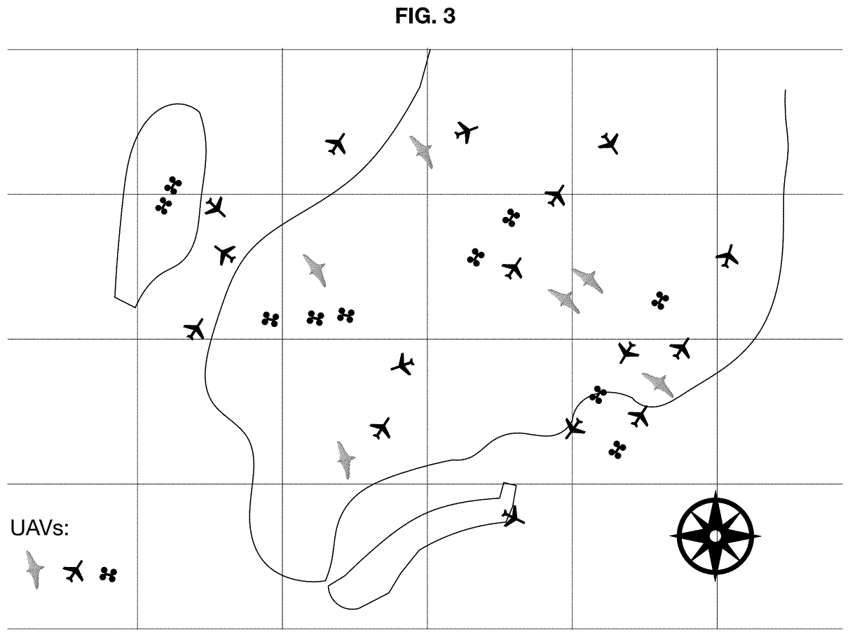

Embodiments of this disclosure comprise a plurality of takeoff and landing stations 101, telecommunications infrastructure 102, a computer-based traffic management system 103, a plurality of unmanned aerial vehicles 104, a communications network 105, a plurality of airspace regions 106 where the UAVs are flown, a traffic control monitoring center 107 for human monitoring of the computer-based traffic management system and a satellite-based navigation system 108, as shown in FIG. 1. The computer-based traffic management system 103 is a computer system that executes automated processes and communicates with one or a plurality of UAVs 104. When a flight request is received, it can determine and assign the best route, flight segments, waypoints and flight parameters required for the mission. To do so, it considers geographical data, weather information, airspace availability and telemetry & flight parameters of other in-network and out-of-network UAVs. A flight route from the origin location 201 to a destination location 202 is defined by a plurality of waypoints 203 which are connected through route segments 204 as shown in FIG. 2. The computer-based traffic management system also tracks a plurality of UAVs, as shown in FIG. 3, using the information contained in the flight plan and the data periodically received from the UAVs, said data including and not limited to telemetry information. This computer based system can be centralized, distributed across multiple data centers or implemented on a cloud-based 111 provider, for example.

The telecommunications infrastructure 102 is the basis of the communications networks 105, shown in FIG. 1, that allows bi-directional information transmission between UAVs and from the UAVs to the computer-based traffic management system. It can comprise multiple communications protocols, a combination of different technologies and different types of air interfaces, for example. In urban areas it can be based on existing 3G, 4G and 5G cellular infrastructure. In unpopulated areas it can be based on microwave links, and in places without communications infrastructure it can be based on satellite communications or on low data rate radio links, for example. The telecommunications infrastructure can include on board transponders. It can also connect to the Internet, for example. The information transmitted between the UAVs and the computer-based traffic management system can be encrypted, for example. The communications network allows UAVs to periodically broadcast their position and allows precise real-time monitoring of the location of all in-network UAVs at all times. In the case of loss of communications due to a natural disaster or lack of telecommunications infrastructure in certain flight paths, the computer-based traffic management system can monitor UAVs flying under such conditions by using a forecast of future flight stages based on the flight plan and the last received telemetry information, for example. This enables the autonomous air traffic control system to manage the flight of planes with and without access to the communications network.

The airspace regions 106 compound the three-dimensional space in which in-network UAVs are flown. Airspace regions can consist of dedicated volumetric regions authorized by governmental aviation authorities for exclusive or non-exclusive UAV operations, for example. It can also dynamically change in size and geographical extent. For instance, temporal access to new airspace regions can be requested and granted from government aviation authorities for certain UAV missions.

For flight maneuvers in places where UAVs have intermittent access or don't have access at all to precise satellite based navigation 108, such as near high rise buildings, the interior of a warehouse or in urban areas, the air traffic control system is compatible with ground-based UAV guidance systems and infrastructure. It can communicate with such systems to achieve precise control of the flight of UAVs specially in maneuvers such as approaching, takeoff and landing, for example.

The present invention also comprises at least one traffic control monitoring center 107 for human monitoring and control of the computer-based traffic management system. The traffic control monitoring center can display in real time flight information of all in-network UAVs. It also enables human intervention in the computer-based air traffic control system, which can accept commands from authenticated humans to re-direct the flight of one a plurality of UAVs in emergency situations, as a request of local aviation authorities or for any other reasonable circumstance. Communications between the traffic control monitoring center(s) and the computer-based traffic management system are strongly encrypted to ensure a safe and secure operation of the AATC.

Embodiments of the computer-based traffic management system 103 also comprise a database 109 for historical recording of data such as flight plans and telemetry information periodically received from each UAV. They also comprise a blockchain 110 for historical recording of part of the flight information that can be accessed and read by third parties that require information about flights. The information in the database can be encrypted, for example.

The invention also comprises a computer-based Artificial Intelligence (AI) system used for but not limited to at least one of the following processes: processing of trip requests, assignation of flight plans, collision likelihood mitigation, flight planning, airspace monitoring and generation of automated alert.

The AATC system includes emergency landing stations which can be located in rooftops or empty pieces of land, for example. They can be used in case of total or partial failure of any UAV subsystem, or in situations wherein destination take-off and landing stations are inaccessible due to a natural disaster such as an earthquake, tsunami, or flooding, for example. In the case of an emergency situation in which the UAV is not fully controllable, such as a severe bird strike, or a severe lightning, for example, the AATC can trigger the on-board parachute or, if aerodynamic control surfaces are still available, the AATC can attempt to glide or ballistically direct the UAV outside densely populated areas, for example.

Service stations are ground stations distributed over airspace regions designated for providing scheduled maintenance and/or reparation services to the UAVs. They can also be used to replace batteries or refuel UAVs in long flights.

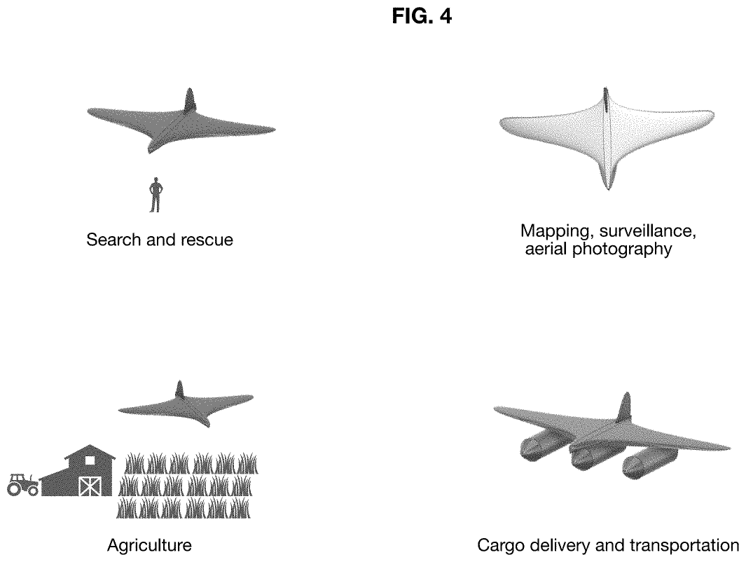

The autonomous air traffic control and method disclosed herein can be used to control AUVs being used for different applications and missions as shown in FIG. 4. Such applications can include and are not limited to cargo delivery, transportation, search and rescue, mapping, surveillance, aerial photography, agriculture, entertainment, wildlife monitoring, mining, remote sensing, law enforcement, real state, infrastructure monitoring, construction monitoring, mining and disaster assessment, for example.

The above description of illustrated embodiments of the invention, including what is described in the “ABSTRACT”, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

### Glossary

Waypoint:
A point in space within a flight route.
Route segment:
A section of a flight route that connects two waypoints.
Telemetry information:
Information collected from on-board systems and sensors that can be broadcasted or transmitted to the computer-based traffic management system and contains at least one of the following: A UAV identification number (UAV ID), ground speed, air speed, pitch rate, yaw rate, roll rate, heading, absolute UAV orientation, throttle level, aileron level, elevator level, rudder level, trim level, flaps level, battery level, fuel level, flight mode, general aircraft status, average and instantaneous energy consumption, service status, range, data from on-board sensors, a combination thereof.
Flight parameters:
Contain at least one of the following: altitude, aircraft ID, ground speed, air speed, pitch rate, yaw rate, roll rate, heading, turning radius, throttle level, aileron level, elevator level, rudder level, trim level, flaps level, flight mode, target energy consumption, a combination thereof.
Flight plan:
Flight information containing at least one of the following: UAV ID, flight ID, origin and destination locations, waypoints; route segments connecting the origin location with the destination location through a plurality of waypoints, location of waypoints, flight parameters per route segment, estimated time of departure (ETA) and estimated time of arrival (ETA), expected duration of each route segment, expected arrival time to each waypoint, service stops, payload information, flight cost, a combination thereof.
In-network UAVs:
UAVs that are registered in the computer-based traffic management system and whose flight is controlled by the AATC system.
Out-of-network UAVs:
UAVs That are not registered in the computer-based traffic management system.

1. A system for autonomous air traffic control of unmanned aerial vehicles (UAVs) comprising:
A plurality of takeoff and landing stations;
Telecommunications infrastructure;
A computer-based traffic management system;
A plurality of unmanned aerial vehicles;
A communications network for bi-directional transmission of data between the computer-based traffic management system and the UAVs; and
A plurality of airspace regions;

2. The system of claim 1, wherein each one of the takeoff and landing stations can be located in any or a combination of items from the following list:
i. A ground station,
ii. A maritime station,
iii. An air station,
iv. A space station,
v. A warehouse,
vi. A balcony,
vii. A backyard,
viii. A roof,
ix. A ground vehicle,
x. An aerial vehicle.

3. The system of claim 1, wherein the computer-based traffic management system can execute any or a combination of automated processes from the following list:
i. Periodically receive data from each UAV,
ii. Receive flight requests, each flight request containing at least an origin location and a destination location,
iii. Generate a flight plan from the origin location to the destination location,
iv. Authorize flight initiation, take-off and landing of the UAVs,
v. Dynamically assign flight plans to each flight request and communicate each flight plan to the respective UAV(s),
vi. Track UAVs using the information contained in the flight plan and the data periodically received from the UAVs, said data including and not limited to telemetry information,
vii. Track UAVs with intermittent or without access to the communications network using the flight plan information and the last data received from the UAVs, said data including and not limited to telemetry information,
viii. Estimate future flight parameters of the UAVs using the flight plan information and the last data received from the UAVs, said data including and not limited to telemetry information,
ix. Ensure safe separation between the UAVs,
x. Dynamically modify the flight plan and flight parameters of individual UAVs based on any of the following: flight priorities, weather conditions, emergency situations, natural disasters, as a request from local aviation authorities, a combination thereof,
xi. Communicate change of flight plans and change of flight parameters to the corresponding UAV(s),
xii. Real-time control of flight parameters of individual UAVs,
xiii. Authenticate UAVs,
xiv. Register new UAVs into the computer-based traffic management system,
xv. Maintain a registry of registered UAVs including at least one of the following information: UAV ID, serial number, model, physical dimensions, maximum takeoff weight, maximum payload dimensions, weight, cruise speed, power consumption, flight range, maximum altitude, maximum and minimum speed, minimum turning radius, maximum ascend rate, maximum decent rate, aircraft type, age, last service and service schedule,
xvi. Transmit information to one or a to plurality of UAVs via the communications network,
xvii. Receive information from one or from a plurality of UAVs via the communications network.
xviii. Acknowledge received information from UAVs,
xix. Ensure safe separation between the UAVs and manned air traffic,
xx. Update a database or blockchain including and not limited to flight plan and telemetry information of flights.

4. The system of claim 3, wherein the telemetry information includes at least one of the items from the following list:
i. Longitude, latitude and altitude,
ii. A UAV identification number (UAV ID),
iii. Ground speed,
iv. Air speed,
v. Pitch rate, yaw rate and roll rate,
vi. Heading,
vii. Absolute UAV orientation,
viii. Throttle level,
ix. aileron, elevator, rudder, trim and flaps level,
x. Battery level,
xi. Fuel level,
xii. Flight mode,
xiii. General aircraft status,
xiv. Average and instantaneous energy consumption,
xv. Service status,
xvi. Range,
xvii. Data from on-board sensors,
xviii. A combination thereof.

5. The system of claim 3, wherein the flight plan information includes at least one of items from the following list:
i. A UAV ID,
ii. A flight ID,
iii. Origin and destination locations,
iv. Waypoints that connect route segments,
v. Route segments connecting the origin location with the destination location through a plurality of waypoints,
vi. Location of waypoints,
vii. Flight parameters per route segment,
viii. Estimated time of departure and estimated time of arrival;
ix. Expected duration of each route segment,
x. Expected arrival time to each waypoint,
xi. Service stops for aircraft service operations such as refueling, battery charge, battery swap, payload swap, UAV maintenance or a combination thereof,
xii. Payload information,
xiii. Flight cost,
xiv. A combination thereof.

6. The system of claim 3, wherein the flight parameters include at leas one of the items from the following list:
i. Altitude,
ii. Aircraft ID,
iii. Ground speed,
iv. Air speed,
v. Pitch rate, yaw rate and roll rate,
vi. Heading,
vii. Turning radius,
viii. Throttle level,
ix. aileron, elevator, rudder, trim and Flaps level,
x. Flight mode,
xi. Target energy consumption,
xii. A combination thereof.

7. The system of claim 1 further comprising at least one of the items from the following list:
i. At least one traffic control monitoring center for human monitoring and control of the computer-based traffic management system,
ii. A plurality of aircraft service stations,
iii. A plurality of emergency landing stations,
iv. A plurality of ground-based or air-based guidance systems for assisting UAVs in maneuvers such as approaching, takeoff and landing,
v. A plurality of navigation augmentation systems,
vi. Means for enforcing geo-fencing to out-of-network UAVs,
vii. Means for periodic transmission of data from UAVs to the computer-based traffic management system, said data including and not limited to UAV ID and telemetry information,
viii. Means for receiving telemetry information from out-of-network UAV operators, out-of-network UAV aircrafts and from hobbyist drones that broadcast telemetry information,
ix. Means to request authorization from aviation authorities to transport one or a plurality of UAVs outside pre-defined transportation airspace regions or outside the plurality of airspace regions mentioned in claim 1,
x. Means for authorized human intervention in the computer-based traffic management system to control one or a plurality of UAVs in situations including but not limited to: emergency situations, natural disasters, severe weather conditions or as a request from local aviation authorities,
xi. A database or decentralized blockchain for historical recording of information including but not limited to flight plans and telemetry information from each UAV,
xii. A plurality of Lidar and radar stations connected to the communications network,
xiii. A computer-based Artificial Intelligence (AI) system used for and not limited to at least one of the following processes: processing of flight requests, assignation of flight plans, collision likelihood mitigation, flight planning, airspace monitoring and generation of automated alerts,
xiv. Means for analyzing data received from a plurality of on-board sensors mounted on the UAVs to prevent UAV malfunctioning and facilitate preventive maintenance,
xv. A combination thereof.

8. The system of claim 1, wherein each UAV further comprises:
Means for broadcasting at least one or a combination of items from the following list:
i. aircraft ID,
ii. telemetry information,
iii. A subset of the flight plan information.

9. The system of claim 1, wherein the communications network is based on the telecommunications infrastructure and can transmit information using any or a combination of technologies and protocols from the following list:
i. Microwave links,
ii. Optical links,
iii. wireless links,
iv. satellite communications,
v. radio waves,
vi. AMPS,
vii. 2G TDMA,
viii. GPRS Edge,
ix. 3G,
x. WiMAX,
xi. CDMA,
xii. OFDM,
xiii. HDPA,
xiv. 4G,
xv. 5G,
xvi. On board transponders,
xvii. Any other technology for analog or digital information transmission.

10. The system of claim 1, wherein said system can be used for different applications including and not limited to: transportation of a plurality of UAVs carrying goods or things, cargo delivery, search and rescue, mapping, surveillance, aerial photography, agriculture, wildlife monitoring, mining, remote sensing, law enforcement, real state, railroad monitoring, construction monitoring and disaster assessment.

11. The system of claim 1, wherein the UAVs are capable of autonomous flight.

12. A method for autonomous air traffic control of unmanned aerial vehicles (UAVs) comprising:
Transporting a plurality of UAVs from an origin location to a destination location through a plurality of airspace regions;
Controlling the flight of said UAVs using a computer-based traffic management system;
Periodically tracking the flight of the UAVs;
Executing automated processes on the computer-based traffic management system; And
Transmitting bi-directional information between the computer-based traffic management system and the UAVs through a communications network.

13. The method of claim 12, wherein the computer-based traffic management system can execute any or a combination of automated processes from the following list:
i. Periodically receiving data from each UAV,
ii. Receiving flight requests, each flight request containing at least an origin location and a destination location,
iii. Generating a flight plan from the origin location to the destination location,
iv. Authorizing flight initiation, take-off and landing of the UAVs,
v. Dynamically assigning flight plans to each flight request and communicating each flight plan to the respective UAVs,
vi. Tracking UAVs using the information contained in the flight plan and the data periodically received from the UAVs, said data including and not limited to telemetry information,
vii. Tracking UAVs with intermittent or without access to the communications network using the flight plan information and the last data received from the UAVs, said data including and not limited to telemetry information,
viii. Estimating future flight parameters of UAVs using the flight plan information and the last data received from the UAVs, said data including and not limited to telemetry information,
ix. Ensuring safe separation between the UAVs.
x. Dynamically modifying the flight plan and flight parameters of individual UAVs based on any of the following: flight priorities, weather conditions, emergency situations, natural disasters, as a request from local aviation authorities, a combination thereof,
xi. Communicating changes of flight plans and flight parameters to the corresponding UAV(s),
xii. Controlling in real-time the flight parameters of individual UAVs,
xiii. Authenticating UAVs,
xiv. Registering new UAVs into the computer-based traffic management system,
xv. Maintaining a registry of registered UAVs including at least one of the following information: UAV ID, serial number, model, physical dimensions, maximum takeoff weight, maximum payload dimensions and weight, cruise speed, power consumption, flight range, maximum altitude, maximum and minimum speed, minimum turning radius, maximum ascend rate, maximum decent rate, aircraft type, age, last service, and service schedule,
xvi. Transmitting information to one or to a plurality of UAVs via the communications network,
xvii. Receiving information from one or from a plurality of UAVs via the communications network.
xviii. Acknowledging received information from UAVs,
xix. Ensuring safe separation between the UAVs and manned air traffic,
xx. Updating a database and a blockchain including and not limited to flight plan and telemetry information of flights.

14. The method of claim 13, wherein the telemetry information includes at least one of the items from the following list:
i. Longitude, latitude and altitude,
ii. A UAV identification number (UAV ID),
iii. Ground speed,
iv. Air speed,
v. Pitch rate, yaw rate and roll rate,
vi. Heading,
vii. Absolute UAV orientation,
viii. Throttle level,
ix. aileron, elevator, rudder, trim and flaps level,
x. Battery level,
xi. Fuel level,
xii. Flight mode,
xiii. General aircraft status,
xiv. Average and instantaneous energy consumption,
xv. Service status,
xvi. Range,
xvii. Data from on-board sensors,
xviii. A combination thereof.

15. The method of claim 13, wherein the flight plan information includes at least one of items from the following list:
i. A UAV ID,
ii. A flight ID,
iii. Origin and destination locations,
iv. Waypoints that connect route segments,
v. Route segments connecting the origin location with the destination location through a plurality of waypoints,
vi. Location of waypoints,
vii. Flight parameters per route segment,
viii. Estimated time of departure and estimated time of arrival,
ix. Expected duration of each route segment,
x. Expected arrival time to each waypoint,
xi. Service stops for aircraft service operations such as refueling, battery charge, battery swap, payload swap, UAV maintenance or a combination thereof,
xii. Payload information,
xiii. Flight cost,
xiv. A combination thereof.

16. The method of claim 13, wherein the flight parameters include at leas one of the items from the following list:
i. Altitude,
ii. Aircraft ID,
iii. Ground speed,
iv. Air speed,
v. Pitch rate, yaw rate and roll rate,
vi. Heading,
vii. Turning radius,
viii. Throttle level,
ix. aileron, elevator, rudder, trim and flaps level,
x. Flight mode,
xi. Target energy consumption,
xii. A combination thereof.

17. The method of claim 12 further comprising at least one of the items from the following list:
i. Human monitoring and controlling of the computer-based traffic management system,
ii. Providing service to the UAVs in a plurality of aircraft service stations,
iii. Emergency landing UAVs in a plurality of emergency landing stations,
iv. Using ground-based or air-based guidance systems for assisting UAV maneuvers such as approaching, takeoff and landing,
v. Using navigation augmentation systems,
vi. Enforcing geo-fencing to out-of-network UAVs,
vii. Periodically transmitting data from UAVs to the computer-based traffic management system, said data including and not limited to UAV ID and telemetry information,
viii. Receiving telemetry information from out-of-network UAV operators, out-of-network UAV aircrafts and from hobbyist drones that broadcast telemetry information,
ix. Requesting authorization from aviation authorities to transport one or a plurality of UAVs outside pre-defined transportation airspace regions or outside the plurality of airspace regions mentioned in claim 12,
x. Performing authorized human intervention in the computer-based traffic management system to control one or a plurality of UAVs in situations including but not limited to: emergency situations, natural disasters, severe weather conditions or as a request from local aviation authorities,
xi. Recording in a database or a decentralized blockchain information including but not limited to flight plans and telemetry information from each UAV,
xii. Transmitting information from Lidar and radar stations to the computer-based traffic control system through the communications network,
xiii. Executing on a computer-based Artificial Intelligence (AI) system at least one of the following processes: processing trip requests, assigning flight plans, reducing likelihood of collisions, planning flight trips, monitoring airspace and generating automated alerts,
xiv. Analyzing data received from a plurality of on-board sensors mounted on the UAVs to prevent UAV malfunctioning and facilitate preventive maintenance.
xv. A combination thereof.

18. The method of claim 12, wherein each UAV performs a broadcasting of at least one or a combination of items from the following list:
xvi. aircraft ID,
xvii. telemetry information,
xviii. heading,
xix. A subset of the flight plan information.

19. The method of claim 12, wherein the communications network is based on the telecommunications infrastructure and can transmit information using any or a combination of technologies and protocols from the following list:
i. Microwave links,
ii. Optical links,
iii. wireless links,
iv. satellite communications,
v. radio waves,
vi. AMPS,
vii. 2G TDMA,
viii. GPRS Edge,
ix. 3G,
x. WiMAX,
xi. CDMA,
xii. OFDM,
xiii. HDPA,
xiv. 4G,
xv. 5G,
xvi. Any other technology for analog or digital information transmission.

20. The method of claim 12, wherein said method can be used for different applications including and not limited to: transportation of a plurality of UAVs carrying goods or things, cargo delivery, search and rescue, mapping, surveillance, aerial photography, agriculture, wildlife monitoring, mining, remote sensing, law enforcement, real state, railroad monitoring, construction monitoring and disaster assessment.

21. The method of claim 12, wherein the UAVs are capable of autonomous flight.
